(19) United States
(12) Patent Application Publication
(10) Pub. No.: US 2004/0104664 A1
(43) Pub. Date: Jun. 3, 2004

(54) Cathode ray tube having an improved core

(76) Inventor: Hae Il Park, Gumi-si (KR)

Correspondence Address: MCKENNA LONG & ALDRIDGE LLP, 1900 K STREET, NW, WASHINGTON, DC, 20006, US

(21) Appl. No.: 10/691,598

(22) Filed: Oct. 24, 2003

(30) Foreign Application Priority Data
Nov. 30, 2002 (KR) 10-2002-0075653

(51) Int. Cl. H01J 31/00

(52) U.S. Cl. 313/479

(57) ABSTRACT

A split core of a cathode ray tube includes an attaching portion that is thicker than an end portion of the core proximate a panel of the cathode ray tube to prevent the formation of cracks in the attaching portion of the core over the lifetime of the core.

This application claims the benefit of Korean Patent Application No. 10-2002-0075653, filed on Nov. 30, 2002, which is hereby incorporated by reference for all purposes as if fully set forth herein.

### BACKGROUND OF THE INVENTION

1. Field of the Invention

The present invention relates to a cathode ray tube, and more particularly to a split core of a cathode ray tube, wherein an attaching portion of the core is thicker than an end portion of the core proximate a panel of the cathode ray tube to prevent the formation of cracks in the attaching portion of the core.

2. Description of the Related Art

FIG. 1 illustrates a related art cathode ray tube while FIG. 2 illustrates a related art deflection yoke.

Referring to FIGS. 1 and 2, the related art cathode ray tube includes a front glass panel 1; a fluorescent screen 2 formed on an interior surface of the panel 1; a shadow mask 3 disposed a predetermined distance from the fluorescent screen 2, wherein the shadow mask 3 enables colors to be selectively expressed; a funnel 4 fastened to the panel 1, thereby forming a vacuum tube; an electron gun 5 housed in a neck part of the funnel 4 for emitting electrons, thereby creating electron beams 6; and a deflection yoke 7 for deflecting electrons within the electron beams 6 in horizontal and vertical directions.

The deflection yoke 7 includes a horizontal deflection coil 8a for horizontally deflecting electrons within the electron beams 6; a vertical deflection coil 8b for vertically deflecting electrons within the electron beams 6; a core 10 for minimizing loss in the strength of a magnetic field generated by the horizontal and vertical deflection coils 8a and 8b, respectively, to thereby improve the efficiency with which the electrons are deflected (i.e., deflection efficiency) by the deflection yoke 7; and a holder 9 for holding and insulating the horizontal and vertical deflection coils 8a and 8b.

Electrons within the electron beams 6 are horizontally and vertically deflected by the deflection yoke 7 and are selectively allowed to pass through portions of the shadow mask 3 to selectively strike the fluorescent screen 2 and display a desired image.

Generally, a current having a frequency in the range of 15.75-95 kHz is applied to the horizontal deflection coil 8a of the deflection yoke 7 to generate a magnetic field capable of horizontally deflecting electrons within the electron beams 6. Further, a current having a frequency of 60 Hz is applied to the vertical deflection coil 8b to generate a magnetic field capable of vertically deflecting electrons within the electron beams 6.

FIG. 3 illustrates a related art core of a the related art cathode ray tube shown in FIG. 1. FIG. 4 illustrates a cross sectional view of the attaching portion shown in FIG. 3 taken along line I-I′ and FIG. 5 illustrates a cross sectional view of the attaching portion shown in FIG. 3 taken along line II-II′.

As shown in FIG. 3, the opening of the end portion core 10 arranged proximate the neck part of the funnel 4 (herein referred to as the neck part of the core 10) is narrower than the opening of the end portion of the core 10 arranged proximate the portion of the funnel 4 attached to the panel 1 (herein referred to as the screen part of the core 10). Generally, cores within the related art cathode ray tubes are provided as one-piece cores or split cores. The core 10 illustrated in FIG. 3 is a split core and facilitates the cathode ray tube manufacturing process because the core 10 includes two split cores that are attached to each other via clamp 15 at attaching portion 12.

FIGS. 4 and 5 illustrate cross sectional views of the attaching portion 12 shown in FIG. 3.

Referring to FIGS. 4 and 5, the attaching portion 12 includes attachment grooves 12a disposed within each of the split cores. The attachment grooves 12a of the split cores are disposed a predetermined distance from contact surface 17 and are coupled together via the clamp 15 disposed within the attachment grooves 12a.

To fabricate the related art core 10 shown in FIGS. 3 to 5, a one-piece core, made out of ferrite material, is heated in a furnace. After the one-piece core is heated, it is split in two. To facilitate splitting of the one-piece core 10, a separation groove having a predetermined depth, similar to a dent, is formed within the one piece core. The predetermined depth of the separation groove is determined such that splitting of the one-piece core does not induce cracks within the separation groove after the core is heated. Korean Laid-Open Publication No. 1992-0022357 discloses a method for manufacturing a split core and is hereby incorporated by reference for all purposes as if fully set forth herein.

To reduce the cost in fabricating split cores and to reduce the size and weight of the split core, a number of split core designs have been suggested. In one such split core design, a thickness t1 of the screen part of the core 10 was reduced such that the thickness of screen part of the core 10 was substantially equal to the average thickness of the core 10. Accordingly, in reducing t1, the average thickness of the core 10 also becomes reduced.

Reducing the thickness of t1 is disadvantageous because, upon reducing the thickness t1 of the screen part the core 10, cracks may be generated within the attachment grooves 12a when the heated one-piece core is about to be split.

More particularly, as the thickness t1 of the screen part of the core 10, measured from the exterior surface of the attaching portion of the core 10 between the attachment grooves 12a to the interior surface of the core 10, is reduced, the thickness t2, measured from the exterior surface of the attachment groove 12a to the interior surface of the core 10, also becomes reduced while the actual depth t3 of the attachment groove 12a, measured as the perpendicular distance from a bottom exterior surface of the attachment grooves 12a to the major exterior surface of the core 10 not between the attachment grooves 12a, remains constant. Accordingly, when t1 is reduced, edges 12b of the attachment grooves 12a can become severely cracked.

Further, the attaching portion 12 can become easily damaged or cracked when the clamp 15 couples the split cores together because a locking force applied by the clamp 15 induces tensile forces within portions of the split cores between the attachment grooves 12a and the contact surface 17. Accordingly, the locking force applied by the clamp 15 may initially generate an insubstantial crack within the spilt cores. The insubstantial crack, however, may propagate, grow within the split cores, and become a fatal defect within the core 10 over the lifetime of the split core 10.

### SUMMARY OF THE INVENTION

Accordingly, the present invention is directed to a cathode ray tube having an improved core that substantially obviates one or more of the problems due to limitations and disadvantages of the related art.

An advantage of the present invention prevents attaching portions of split cores of a cathode ray tube from cracking.

Another advantage of the present invention provides a split core having an attaching portion with a thickness greater than the thickness of a portion of the core proximate a portion of a funnel fastened to a panel.

Another advantage of the present invention prevents an attaching portion of a split core from cracking by forming an attachment groove wherein a bottom exterior surface of the attachment groove and a surface contactable by a clamp are joined together at a corner having a curvature with a predetermined radius to disperse tensile forces within the attaching portion of the core induced by the clamp.

Another advantage of the present invention provides a core having a reduced thickness, thereby reducing the size, weight, and manufacturing cost of the cathode ray tube while increasing the magnetic efficiency of magnetic fields induced by horizontal and vertical deflection coils.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a cathode ray tube may for example include a glass front panel; a funnel fastened to the panel; a fluorescent screen formed on the interior surface of the panel; a shadow mask disposed a predetermined distance from the fluorescent screen for enabling colors to be selectively expressed; an electron gun housed in a neck part of the funnel for emitting electrons within electron beams; and a deflection yoke for deflecting the electrons within the electron beams in horizontal and vertical directions, wherein the deflection yoke may, for example, include a horizontal deflection coil for horizontally deflecting electrons within the electron beams; a vertical deflection coil for vertically deflecting electrons within the electron beams; a core for reducing loss in the strength of a magnetic field generated by the horizontal and vertical deflection coils to thereby improve deflection efficiency of the deflection yoke; and a holder for holding and insulating the horizontal and vertical deflection coils, wherein, the core includes an attaching portion having two attachment grooves, and wherein, along a cross section perpendicular to an axis of the funnel, a thickness of the attaching portion of the core between the two attachment grooves is different from a thickness of a portion of the core proximate a portion of the funnel fastened to the panel.

In another aspect of the present invention a cathode ray tube may, for example, include a glass front panel; a funnel fastened to the panel; a fluorescent screen formed on the interior surface of the panel; a shadow mask disposed a predetermined distance from the fluorescent screen for enabling colors to be selectively expressed; an electron gun housed in a neck part of the funnel for emitting electrons within electron beams; and a deflection yoke for deflecting the electrons within the electron beams in horizontal and vertical directions, wherein the deflection yoke may, for example, include a horizontal deflection coil for horizontally deflecting electrons within the electron beams; a vertical deflection coil for vertically deflecting electrons within the electron beams; a core for reducing loss in the strength of a magnetic field generated by the horizontal and vertical deflection coils to thereby improve deflection efficiency of the deflection yoke; and a holder for holding and insulating the horizontal and vertical deflection coils, wherein, the core includes an attaching portion having two attachment grooves, and wherein, along a cross section perpendicular to an axis of the funnel, a thickness of the attaching portion of the core between the two attachment grooves is different from an average thickness of the core excluding the thickness of the core in the region between the two attachment grooves.

In yet another aspect of the present invention, the thickness of the core in the region between the two attachment grooves may be greater than the thickness of portion of the core proximate the portion of the funnel fastened to the panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a related art cathode ray tube;

FIG. 2 illustrates a related art deflection yoke;

FIG. 3 illustrates a related art core of a the related art cathode ray tube shown in FIG. 1;

FIG. 4 illustrates a cross sectional view of the attaching portion shown in FIG. 3 taken along line I-I′;

FIG. 5 illustrates a cross sectional view of the attaching portion shown in FIG. 3 taken along line II-II′;

FIG. 6 illustrates a cathode ray tube according to the principles of the present invention;

FIG. 7 illustrates a deflection yoke in accordance with the present invention;

FIG. 8 illustrates a core, according to principles of one aspect of the present invention, of the cathode ray tube shown in FIG. 6;

FIG. 9 illustrates a cross sectional view taken of the attaching portion shown in FIG. 8 taken along line III-III′;

FIG. 10 illustrates a cross sectional view of the attaching portion shown in FIG. 8 taken along line IV-IV′;

FIG. 11 illustrates the relationship between the clamp and the attachment grooves of the core according to the principles of the present invention;

FIG. 12 illustrates a core, according to principles of another aspect of the present invention, of the cathode ray tube shown in FIG. 6;

FIG. 13 illustrates a cross sectional view taken of the attaching portion shown in FIG. 12 taken along line III-III′;

FIG. 14 illustrates a deflection yoke mounting portion of a funnel;

FIG. 15 illustrates a core of a cathode ray tube according to principles of another aspect of the present invention; and

FIG. 16 illustrates a core of a cathode ray tube according to principles of another aspect of the present invention;

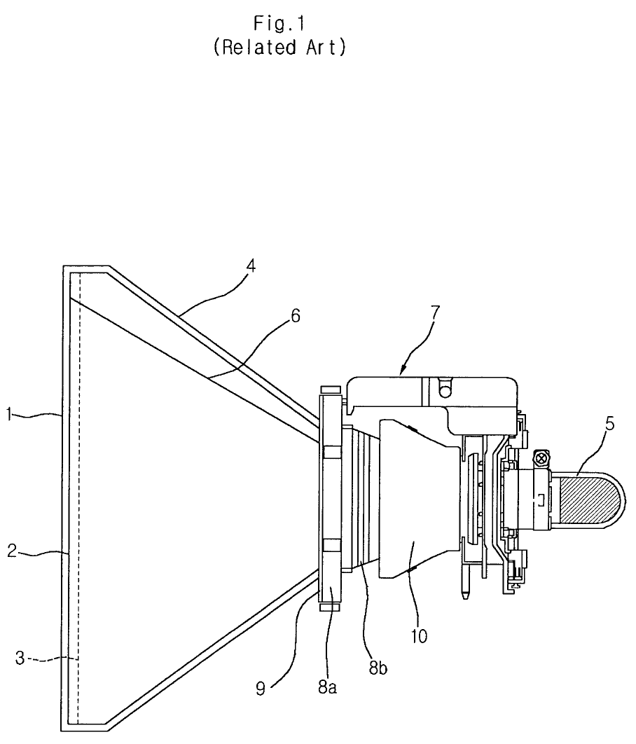

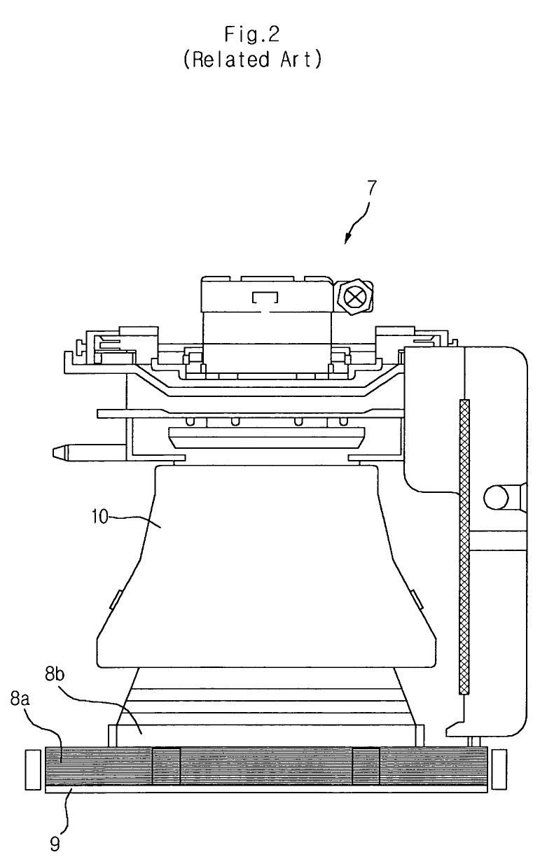

### DETAILED DESCRIPTION OF THE ILLUSTRATED EMBODIMENTS

Reference will now be made in detail to an embodiment of the present invention, examples of which are illustrated in the accompanying drawings.

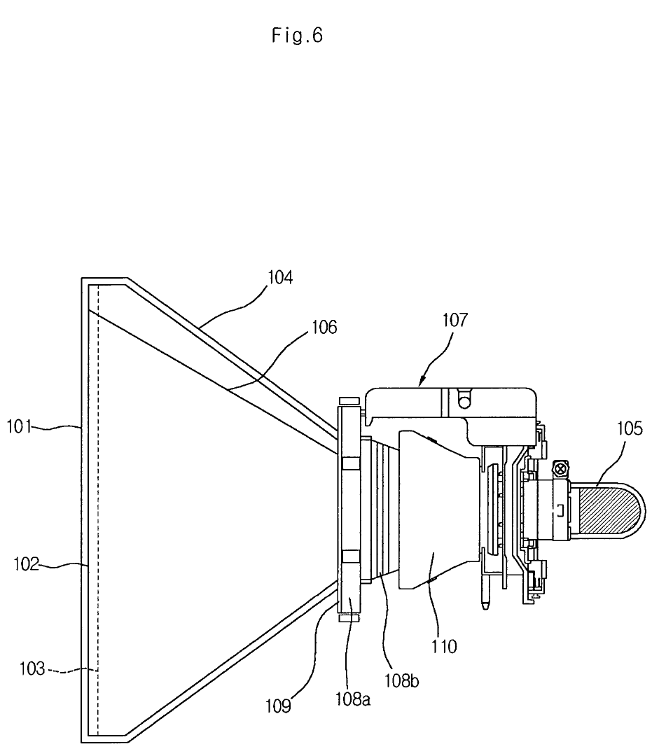

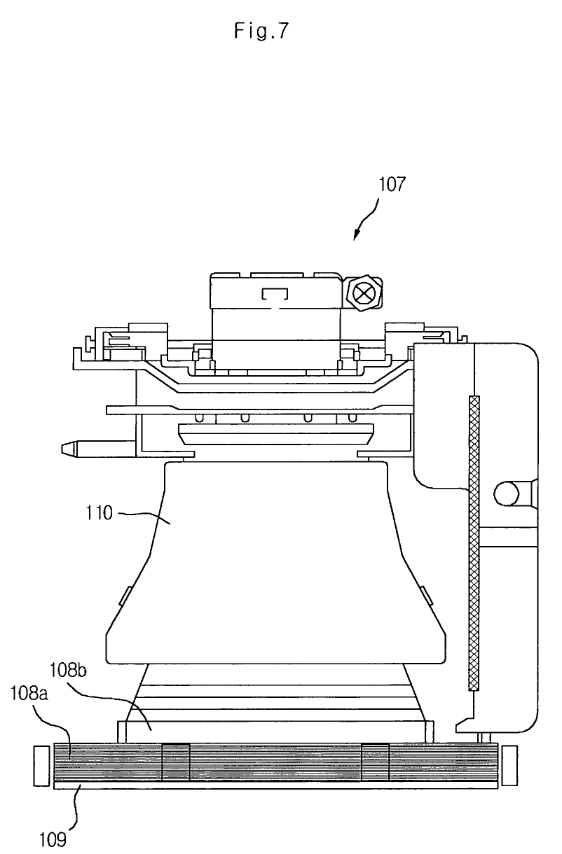

FIG. 6 illustrates a cathode ray tube in accordance with the present invention, while FIG. 7 illustrates a deflection yoke used within the cathode ray tube shown in FIG. 7.

Referring to FIGS. 6 and 7, the cathode ray tube according to the principles of the present invention may, for example, includes a front glass panel 101; a fluorescent screen 102 formed on an interior surface of the panel 101; a shadow mask 103 disposed a predetermined distance from the fluorescent screen 102, wherein the shadow enables colors to be selectively expressed; a funnel 104 having a neck part and a screen part, wherein the screen part that is fastened to the panel 101 and forms a vacuum tube; an electron gun 105 housed in the neck part of the funnel 104 for emitting electrons and thereby creating electron beams 106; and a deflection yoke 107 for deflecting electrons within the electron beams 106 in horizontal and vertical directions.

The deflection yoke 107 may, for example, include a horizontal deflection coil 108a for horizontally deflecting electrons within the electron beams 106; a vertical deflection coil 108b for vertically deflecting electrons within the electron beams 106; a core 110 for reducing loss in the strength of a magnetic field generated by the horizontal and vertical deflection coils 108a and 108b, respectively, to thereby improve deflection efficiency of the deflection yoke 107; and a holder 109 for holding and insulating the horizontal and vertical deflection coils 108a and 108b.

Electrons within the electron beams 106 may be horizontally and vertically deflected by the deflection yoke 107 and may be selectively allowed to pass through portions of the shadow mask 103 to selectively strike the fluorescent screen 102 and display a desired image.

In one aspect of the present invention, a current having a frequency between about 15.75 and about 95 kHz may be applied to the horizontal deflection coil 108a of the deflection yoke 107 to generate a magnetic field capable of horizontally deflecting electrons within the electron beams 106. Further, a current having a frequency of about 60 Hz may be applied to the vertical deflection coil 108b to generate a magnetic field capable of vertically deflecting electrons within the electron beams 106.

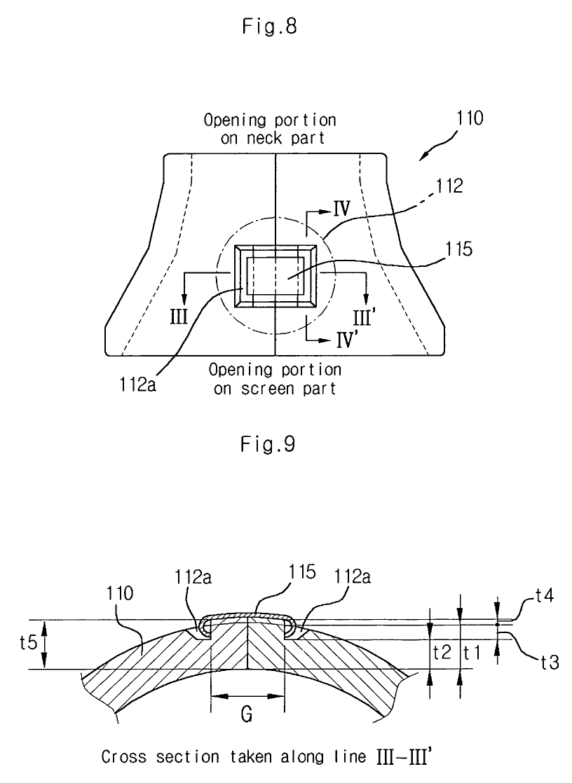

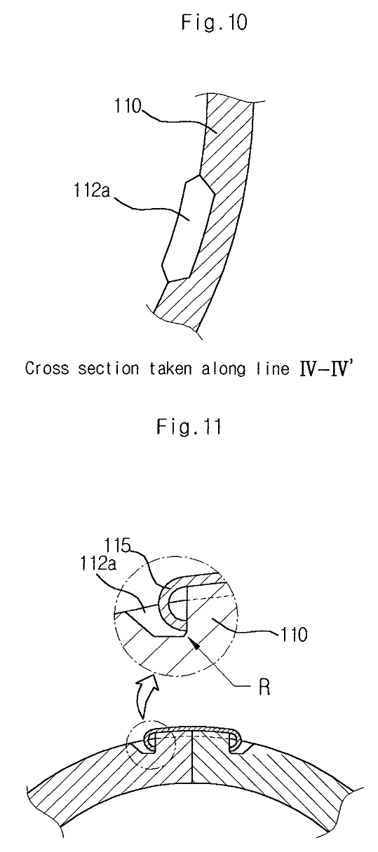

FIG. 8 illustrates a core, according to principles of one aspect of the present invention, of the cathode ray tube shown in FIG. 6. FIG. 9 illustrates a cross sectional view taken of the attaching portion shown in FIG. 8 taken along line III-III′ and FIG. 10 illustrates a cross sectional view of the attaching portion shown in FIG. 8 taken along line IV-IV′.

Referring to FIGS. 8 to 10, the core 110, according to principles of one aspect of the present invention, may be provided as a split core and may be attached to the deflection yoke 107 via clamp 115 at attaching portion 112.

As shown in FIG. 8, the opening of the end portion of the core 110 arranged proximate a neck part of a funnel 104 (herein referred to as the neck part of the core 110) is narrower than the portion of the core 110 arranged proximate the opening of the end portion of the funnel 104 attached to the panel such that the core 110 has a trapezoidal shape (herein referred to as the screen part of the core 110). The attaching portion 112 may include attachment grooves 112a disposed within the split cores of the core 110. The split cores may be coupled together to form core 110 by inserting or fitting the clamp 115 into and between the attachment grooves 112a.

Referring to FIG. 9, a cross sectional view of the attaching portion 112, oriented substantially perpendicularly to the axis of the funnel 104, illustrates that a thickness t5 of an attaching portion 112 of the core 110 between the two attachment grooves 112a, measured from the exterior surface of the attaching portion of the core 110 between the attachment grooves 112a to the interior surface of the core 110, which may be different from a thickness t1 of the screen part of the core 110, measured from the exterior surface of the screen part of the core 110 to the interior surface of the core 110. In one aspect of the present invention, the thickness of the screen part of the core 110 may be substantially equal to the average thickness of the core 110. Accordingly, the thickness t5 of the attaching portion 112 of the core 110 between the two attachment grooves 112a may be different from the average thickness of the core 110 excluding the portion of the core 110 between the attachment grooves 112a.

In one aspect of the present invention, the thickness t5 of the attaching portion 112 of the core 110 between the two attachment grooves 112a may be greater than the thickness t1 of the screen part of the core 110. Accordingly, upon applying the principles of the present invention, the generation of cracks may be prevented within the attaching portion of the core 110, even as the thickness of the core 110 is reduced, while the loss in the strength of magnetic field generated by the horizontal and vertical deflection coils may be minimized.

In one aspect of the present invention, the thickness t5 of the attaching portion 112 of the core 110 between the two attachment grooves 112a may be between about 4 mm and about 6 mm.

In another aspect of the present invention, the thickness t1 of the screen part of the core 110 may be between about 3 mm and about 6 mm. In yet another aspect of the present invention, the thickness t1 of the screen part of the core 110 may be between about may be between about 4 mm and about 5 mm.

Still referring to FIG. 9, the actual depth t3 of the attachment grooves 112a, measured as the perpendicular distance from a bottom exterior surface of the attachment grooves 112a to the major exterior surface of the core 110 not between the attachment grooves 112a, may be about ⅓ to about ⅔ the thickness t5 of the attaching portion 112 of the core 110 between the two attachment grooves 112a. In another aspect of the present invention, the actual depth t3 of the attachment groove 112a of the present invention may be between about 2 mm and about 3.5 mm.

Because the thickness t5 of the attaching portion 112 of the core 110 between the two attachment grooves 112a may be greater than the thickness t1 of the attaching portion of the related art core 10 between the two attachment grooves 12a, the actual depth t3 of the attachment grooves 112a of the present invention may be shallower than the actual depth t3 of the related art attachment grooves 12a. According to the principles of the present invention, providing the relatively shallower attachment grooves 112a may prevent the generation of cracks within the core 110 over the lifetime of the core 110.

In one aspect of the present invention, forming a gap (G) between the two attachment grooves 112a of about 10 mm to about 14 mm may optimize the locking force applied by the clamp 15 and facilitate insertion of the clamp into the attachment grooves 112a.

To fabricate the core 110 according to the principles of the present invention, a molded core, made of ferrite material, may be heated in a furnace. Upon heating, the size of the molded core contracts about 15% to about 30% the pre-heated sized. Accordingly, the final dimensions of the core 110 should be designed taking into account the aforementioned shrinkage characteristics of the molded core upon heating.

In one aspect of the present invention, the core 110 may be split to facilitate assembly of the cathode ray tube. To facilitate splitting of the core 110, a separation groove having a predetermined depth may be formed within the molded core prior to heating. The separation groove creates a weakness at predetermined regions of the molded core. Accordingly, after the molded core having the separation groove is heated, the separation groove causes the molded core to crack and thus split.

Upon assembly of the cathode ray tube, the split cores may be coupled to each other and attached to a deflection yoke to form a unitary body, wherein the split cores are held together around the funnel 104 by inserting the clamp 115 into the attachment grooves 112a. As mentioned above, the deflection yoke 107 may be provided with a horizontal deflection coil 108a and a vertical deflection coil 108b. In another aspect of the present invention, the horizontal deflection coil 108a may be provided as a saddle type deflection coil. In yet another aspect of the present invention, the vertical deflection coil 108b may be provided as either a saddle type or a toroidal type deflection coil.

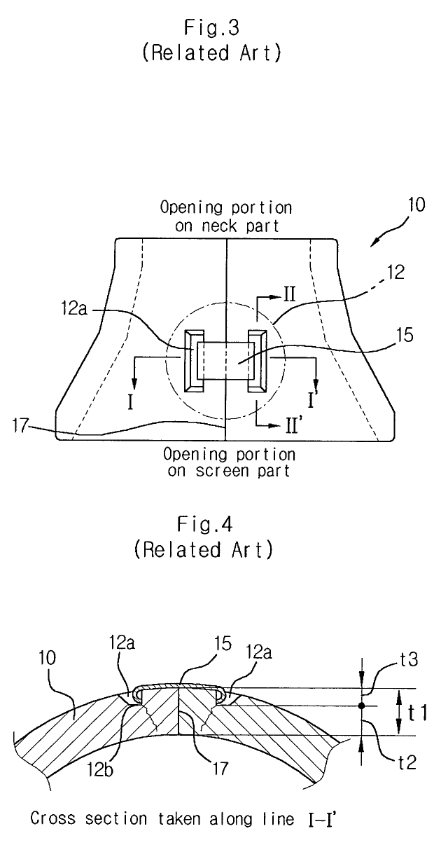

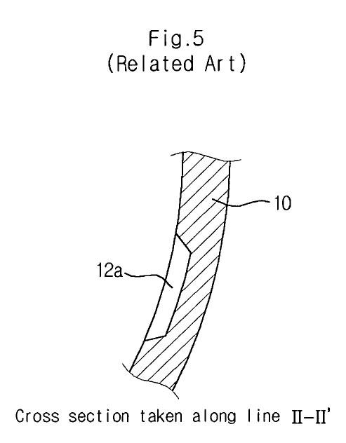

The related art cores 10 such as those shown in FIGS. 3 to 5 weigh about 240 g to about 260 g. As mentioned above, related art approaches to reduce the fabrication cost, size, and weight of the split cores involve reducing the thickness of the core. As shown above reducing the thickness of a core in the manner described by the related art may weaken the strength and integrity of attachment grooves 12a compared to other portions of the core. According to the principles of the present invention, however, the core 110 shown in FIGS. 8 to 10 weighs about 160 g to about 180 g and may be formed considerably thinner than the related art core 10 shown in FIGS. 3 to 5 while not significantly weakening strength and integrity of attachment grooves 112a because the thickness t5 of the attaching portion 112 of the core 110 between the two attachment grooves 112a may be greater than the thickness t1 of the screen part of the core 110.

In view of the fact that the strength of the core 110 may be severely weakened if the thickness t2, measured from the exterior surface of the attachment groove 112a to the interior surface of the core 110, is extremely thin, the thickness t5 of the attaching portion 112 of the core 110 between the two attachment grooves 112a may be provided to protrude greater than the thickness t1 of the screen part of the core 110 by a predetermined thickness t4. Although not shown in the figures, the shape of the protrusion of the attaching portion 112 above the core 110 may have a substantially rectangular cross-section, a substantially trapezoidal cross-section or any other shape to facilitate attachment of the clamp 115 to the attaching portion 112.

Therefore, the actual depth t3 of the attachment groove 112a may be relatively shallower than the actual depth t3 of the aforementioned related art attachment groove 12a while the thickness t2 from the attachment groove 112a to the interior surface of the core 110 may be greater than the thickness t2 of the aforementioned related art attachment groove 12a to the interior surface of the core 10.

FIG. 11 illustrates the relationship between the clamp 115 and the attachment grooves 112a of the core 110 according to the principles of the present invention.

Referring to FIG. 11, a bottom exterior surface of the attachment grooves 112a and a surface contactable by clamp 115 may be joined together at a corner having a curvature with a predetermined radius, R, wherein 1 mm≦R≦2 mm. According to the principles of the present invention, the corner having the predetermined radius R may disperse tensile forces within the attaching portion 112 of the core 110 induced by the clamp 115 and the generation of cracks within the core 110 may be minimized. Further according to the principles of the present invention, the locking force may be applied from the clamp 115 to the attaching portion 112 of core 110 more effectively compared to the related art because the exterior surface of the attaching portion 112 of the core 110 between the contact grooves 112a protrudes from the exterior surface of the attaching portion of the core 110 excluding the region between the attachment grooves 112a. In another aspect of the present invention, the exterior surface of the attaching portion 112 of the core 110 between the contact grooves 112a protrudes from the major exterior surface of the core 110. Accordingly, the contact area between the clamp 115 and the attachment grooves 112a is reduced.

Referring to FIGS. 6, 7, 12 and 13, the core 110, according to principles of one aspect of the present invention, may be provided as a split core and may be attached to the deflection yoke 207 via clamp 215 at attaching portion 212.

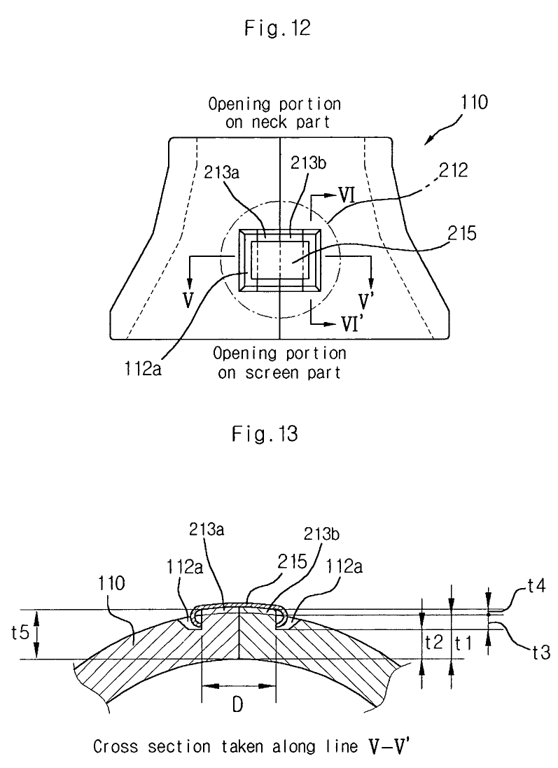

As shown in FIG. 12 and FIG. 13, the opening of the end portion of the core 110 arranged proximate a neck part of a funnel 104 (herein referred to as the neck part of the core 110) is narrower than the portion of the core 110 arranged proximate the opening of the end portion of the funnel 104 attached to the panel such that the core 110 has a trapezoidal shape (herein referred to as the screen part of the core 110). The attaching portion 212 may include protrusions 213a and 213b disposed adjacent to the edges of the split cores of the core 110. The split cores may be coupled together to form core 110 by inserting or fitting the clamp 215 over the protrusions 213a and 213b.

Referring to FIG. 13, a cross sectional view of the attaching portion 212, oriented substantially perpendicularly to the axis of the funnel 104, illustrates that a thickness t5 of an attaching portion 212 of the core 110 including the protrusions 213a and 213b, measured from the exterior surface of the attaching portion 212 of the core 110 including the protrusions 213a and 213b to the interior surface of the core 110, which may be different from a thickness t1 of the screen part of the core 110, measured from the exterior surface of the screen part of the core 110 to the interior surface of the core 110. In one aspect of the present invention, the thickness of the screen part of the core 110 may be substantially equal to the average thickness of the core 110. Accordingly, the thickness t5 of the attaching portion 212 of the core 110 including the protrusions 213a and 213b may be different from the average thickness of the core 110 excluding the protrusions 213a and 213b.

In one aspect of the present invention, the thickness t5 of the attaching portion 212 of the core 110 including the protrusions 213a and 213b may be greater than the thickness t1 of the screen part of the core 110. Accordingly, upon applying the principles of the present invention, the generation of cracks may be prevented within the attaching portion of the core 110, even as the thickness of the core 110 is reduced, while the loss in the strength of magnetic field generated by the horizontal and vertical deflection coils may be minimized.

In one aspect of the present invention, the thickness t5 of the attaching portion 212 of the core 110 including the protrusions may be between about 4 mm and about 7 mm.

In another aspect of the present invention, the thickness t1 of the screen part of the core 110 may be between about 3 mm and about 6 mm. In yet another aspect of the present invention, the thickness t1 of the screen part of the core 110 may be between about may be between about 4 mm and about 5 mm.

Still referring to FIG. 13, the actual thickness t2 of the core 110 not in the regions of the protrusions, measured as the perpendicular distance from a bottom exterior surface of the core 110 to the major exterior surface of the core 110 not including the protrusions 213a and 213b may be about ⅔ to about ⅔ the thickness t5 of the attaching portion 212 of the core 110 including the protrusions 213a and 213b.

Because the thickness t5 of the attaching portion 212 of the core 110 including the protrusions 213a and 213b may be greater than the thickness t1 of the attaching portion of the related art core 20 between the two attachment grooves 22a, attachment grooves 22a are not necessary. According to the principles of the present invention, providing the attachment portion 212 of the core 110 to include protrusions 213a and 213b may prevent the generation of cracks within the core 110 over the lifetime of the core 110.

In one aspect of the present invention, forming a distance (D) between outer edges of the protrusions 213a and 213b of about 20 mm to about 24 mm may optimize the locking force applied by the clamp 215. Although not shown in the figures, the protrusions 213a and 213b of the various embodiments of the present invention taken together may have a substantially rectangular cross-section, a substantially trapezoidal cross-section or any other shape to facilitate attachment of the clamp 215 to the protrusions.

The core 110 according to the principles of the present invention may be fabricated as discussed above with respect to forming the core 110 of the embodiment illustrated in FIGS. 8 to 10.

The related art cores 10 such as those shown in FIGS. 3 to 5 weigh about 240 g to about 260 g. As mentioned above, related art approaches to reduce the fabrication cost, size, and weight of the split cores involve reducing the thickness of the core. As shown above reducing the thickness of a core in the manner described by the related art may weaken the strength and integrity of attachment grooves 12a compared to other portions of the core. According to the principles of the present invention, however, the core 110 shown in FIGS. 12 to 13 weighs about 160 g to about 180 g and may be formed considerably thinner than the related art core 10 shown in FIGS. 3 to 5, while not significantly weakening strength and integrity of attaching portion 212 because the thickness t5 of the attaching portion 212 of the core 110 including the protrusions 213a and 213b may be greater than the thickness t1 of the screen part of the core 110.

In view of the fact that the strength of the core 110 may be severely weakened if the thickness t2, measured from the exterior surface of the attachment groove 212a to the interior surface of the core 110, is extremely thin, the thickness t5 of the attaching portion 212 of the core 110 including the protrusions 213a and 213b may be provided greater than the thickness t1 of the screen part of the core 110 by a predetermined thickness t4.

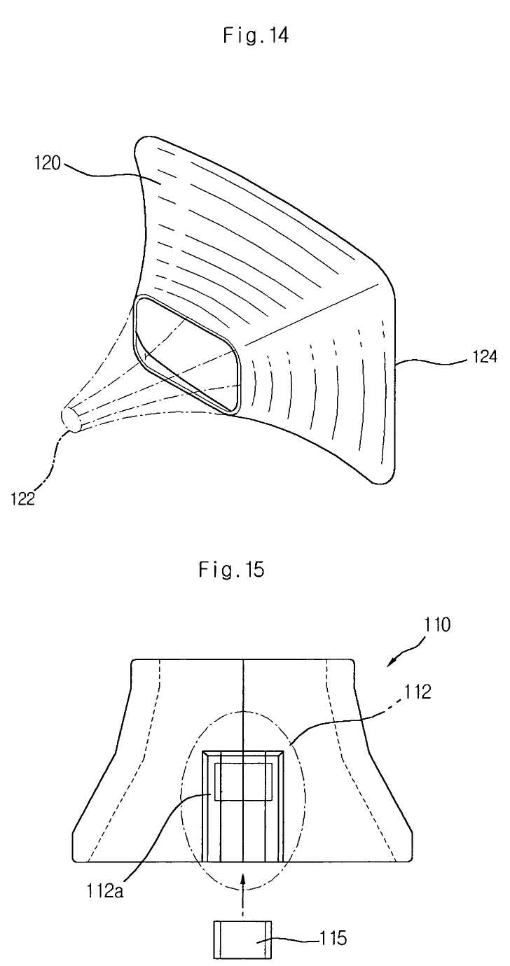

FIG. 14 illustrates a yoke mounting portion 120 of a funnel.

Referring to FIG. 14, the deflection yoke 107, to which the core 110 may be mounted, may be variously configured depending on the shape of the yoke mounting portion of funnel 104. In one aspect of the present invention, the interior or exterior surfaces of the funnel 104 have a cross section, perpendicular to the axis of the funnel 104, that gradually changes from a substantially circular shape at the neck part 122 of the funnel 104 to a substantially non-circular shape at the screen part 124 of the funnel 104.

As the shape of the funnel 104 gradually changes from substantially circular to substantially non-circular, the horizontal and vertical deflection coils within the deflection yoke may have a cross section, perpendicular to the axis of the funnel, that is substantially oblong.

Upon assembly of the cathode ray tube illustrated in FIG. 6, the aforementioned funnel 104, horizontal and vertical deflection coils 108a and 108b, respectively, and core 110 may be assembled together wherein the loss of the strength in a magnetic field generated by the horizontal and vertical deflection coils may be reduced compared to the loss of the strength in a magnetic field generated by the horizontal vertical deflection coils in the cathode ray tube incorporating the related art core 10. According to the principles of the present invention, the core 110 allows the distance between the electron beams generated by the electron gun and the deflection coils to be smaller than the core 10 of the related art.

FIG. 15 illustrates a core of a cathode ray tube according to principles of another aspect of the present invention.

Referring to FIG. 15, the attachment groove 112a in one aspect of the present invention may be extended to the screen part of the core 110. Accordingly, insertion of the clamp 115 into the attachment grooves 112a may be facilitated due to the extension of the attachment groove 112a to the screen part of the core 110. Moreover, the clamp 115 may be arranged over a range of portions of the core 110 depending on the shape of the cross section of the attachment grooves 112a or on the locking force of the clamp 15.

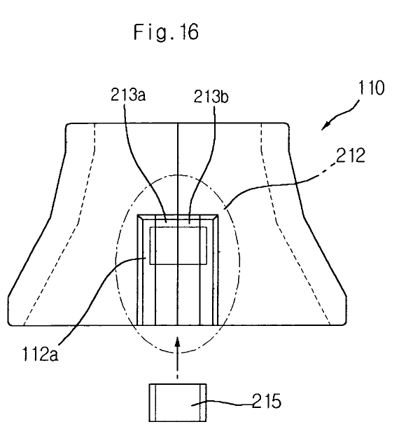

Referring to FIG. 16, the attachment portion 212 including the protrusions 213a and 213b in another aspect of the present invention may be extended to the screen part of the core 110. Accordingly, insertion of the clamp 215 over the protrusions 213a and 213b may be facilitated due to the extension of the protrusions 213a and 213b to the screen part of the core 110. Moreover, the clamp 215 may be arranged over a range of portions of the core 110 depending on the shape of the cross section of protrusions 213a and 213b or on the locking force of the clamp 215.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A cathode ray tube, comprising:
a glass front panel;
a funnel fastened to the panel, the funnel including a neck part and a screen part opposing the neck part, wherein the screen part is fastened to the panel;
a fluorescent screen formed on an interior surface of the panel;
a shadow mask disposed a predetermined distance from the fluorescent screen;
an electron gun coupled to the neck part for emitting electron beams, the electron beams formed of a plurality of electrons;
a deflection yoke for deflecting electrons within the electron beams in horizontal and vertical directions, wherein the deflection yoke includes a horizontal deflection coil for horizontally deflecting electrons within the electron beams and a vertical deflection coil for vertically deflecting electrons within the electron beams;
a core for reducing loss in the strength of a magnetic field generated by the horizontal and vertical deflection coils, the core including an attaching portion; and
a holder for holding and insulating the horizontal and vertical deflection coils, wherein
along a cross section perpendicular to an axis of the funnel, a thickness of the attaching portion of the core is different from a thickness of a portion of the core proximate a portion of the funnel fastened to the panel.

2. The cathode ray tube according to claim 1, wherein the thickness of the attaching portion is greater than the thickness of the portion of the core proximate the screen part.

3. The cathode ray tube according to claim 1, wherein the thickness of the portion of the core proximate the screen part is about 3 mm to about 6 mm.

4. The cathode ray tube according to claim 3, wherein the thickness of the portion of the core proximate the screen part is about 4 mm to about 5 mm.

5. The cathode ray tube according to claim 3, wherein the thickness of the attaching portion of the core is about 4 mm to about 6 mm.

6. The cathode ray tube according to claim 1, wherein the thickness of the attaching portion of the core is about 4 mm to about 6 mm.

7. The cathode ray tube according to claim 1, wherein thickness of the core adjacent the attaching portion is about ⅓ to about ⅔ the thickness of the core including the attaching portion.

8. The cathode ray tube according to claim 1, further comprising attachment grooves along an edge portion of the attaching portion.

9. The cathode ray tube according to claim 8, wherein the depth of the attachment grooves is about ⅓ to about ⅔ the thickness of the attaching portion of the core between the attaching grooves.

10. The cathode ray tube according to claim 8, wherein an actual depth of the attachment grooves is about 2 mm to about 3.5 mm.

11. The cathode ray tube according to claim 8, wherein the two attachment grooves are spaced apart from each other by a distance of about 10 mm to about 14 mm.

12. The cathode ray tube according to claim 1, wherein an exterior surface of the attaching portion of the core between the attachment grooves protrudes from the major exterior surface of the core.

13. The cathode ray tube according to claim 1, wherein the core includes ferrite.

14. The cathode ray tube according to claim 8, wherein a bottom exterior surface of the attachment groove and a surface contactable by a clamp are joined together at a corner having a curvature with a predetermined radius, R.

15. The cathode ray tube according to claim 14, wherein R is between about 1 mm and about 2 mm.

16. The cathode ray tube according to claim 8, wherein the attachment grooves extend to the end portion of the core proximate the screen part.

17. The cathode ray tube according to claim 1, wherein the core weighs between about 160 g and about 180 g.

18. The cathode ray tube according to claim 1, wherein an interior surface of the funnel has a cross section, perpendicular to the axis of the funnel, that gradually changes from a substantially circular shape at the neck part to a substantially non-circular shape at the screen part.

19. The cathode ray tube according to claim 1, wherein an exterior surface of the funnel has a cross section, perpendicular to the axis of the funnel, that gradually changes from a substantially circular shape at the neck part to a substantially non-circular shape at the screen part.

20. A core of a cathode ray tube, comprising:
a pair of split cores fixable to each other, wherein a first opening and a second opening opposing the first opening are definable by the pair of split cores;
an attaching portion wherein a protruding portion of attaching portion protrudes above an exterior surface of the split cores.

21. The core according to claim 20, further comprising attachment grooves adjacent the attachment portion wherein the thickness of the split cores between the attachment grooves is different than a thickness of a portion of the split cores defining the first opening.

22. The core according to claim 21, wherein the thickness of the split cores between the attachment grooves is greater than a thickness of a portion of the split cores defining the first opening.

23. The core according to claim 20 wherein the thickness of a portion of the split cores defining the first opening is about 3 mm to about 6 mm.

24. The core according to claim 23, wherein the thickness of a portion of the split cores defining the first opening is about 4 mm to about 5 mm.

25. The core according to claim 21 wherein the thickness of the split cores between the attachment grooves is about 4 mm to about 6 mm.
